(19) United States
(12) Patent Application Publication
(10) Pub. No.: US 2007/0023080 A1
(43) Pub. Date: Feb. 1, 2007

(54) Rotary drive for a panel-shaped solar module and solar system

(76) Inventors: Guenther Thurner, Strasskirchen (DE); Klaus Krinner, Strasskirchen (DE)

Correspondence Address: JORDAN AND HAMBURG LLP, 122 EAST 42ND STREET, SUITE 4000, NEW YORK, NY, 10168, US

(21) Appl. No.: 11/484,278

(22) Filed: Jul. 11, 2006

(30) Foreign Application Priority Data
Jul. 28, 2005 (DE) 10 2005 035 441.6

(51) Int. Cl. H02N 6/00

(52) U.S. Cl. 136/246

(57) ABSTRACT

In a rotary drive for rotating a panel-shaped solar module, rotary pulses with a limited rotational path are introduced from outside only by step. A rotatable gear disk in the rotary drive has a regularly ratcheted control contour with ratchet units like teeth. In cooperation with a control member, what this attains is that the rotatable gear disk returns to a defined stable starting/center position when rotating up to a limiting angle, but when the limiting angle is exceeded advances at least one ratchet unit. The solar module is connected rotation-fast to the gear disk. What this embodiment attains is that the positioning accuracy of the solar module is largely independent of the rotary pulse introduced from outside. This means that a group of rotary drives can be rotated jointly with a central drive via mechanical coupling links, and despite the inaccuracies of a mechanical coupling there is good and uniform positioning accuracy for the individual solar modules.

The invention relates to a rotary drive for a panel-shaped solar module that adjusts to the direction of solar radiation.

The solar modules can be photovoltaic modules or thermal solar modules. It is known to arrange such solar modules pivotably in order for them to track the direction of solar radiation. The solar modules are pivoted about upright axes, which causes them to track the apparent daily path of the sun. The expression “upright” means that the support axis to which the solar modules are attached and on which the solar modules are supported stand perpendicular or upwardly inclined on the surface of the earth. In addition, pivoting about largely horizontal axes is known, which is used to account for the different elevations of the sun depending on the time of year. In large solar systems there is a plurality of individual panel-shaped solar modules that, if they can be repositioned, are all jointly directed at the sun. In the interest of a large energy yield, all solar modules should assume the same optimum position to the extent possible. In order to attain this, each individual solar module could be provided with a discrete positioning drive and a discrete measurement cell in order to attain optimum control. Such a system would be very complex and also requires a great deal of maintenance, which would have a significantly negative effect on overall efficiency.

Also known are devices for mechanically transmitting the positioning movement from a common drive and control unit. This can occur e.g. using chain drives or control rods that are actuated by a common drive motor. However, mechanical transmission has the disadvantage that on the one hand substantial positioning forces must be transmitted and on the other hand high positioning accuracy and uniformity are required for all of the individual solar modules. At the end of a lengthy mechanical transmission chain, the individual solar modules will perform a distinctly smaller positioning movement because, due to slack and friction in the transmission members, only a portion of the movement provided by the central positioning motor will reach the last solar module.

Given the great design complexity and financial outlay required for a common positioning system, there is thus a need to attain the best possible result, i.e. the most precise and uniform possible tracking of the positioning movement for all solar modules.

The underlying object of the invention is therefore to improve the rotary drive for a panel-shaped solar module with the goal that a central drive is attained for a plurality of solar modules in an economic manner, whereby however the highest possible positioning accuracy is attained for each solar module and the most uniform possible positioning accuracy is attained for all of the positioning modules.

This object is attained with a rotary drive in accordance with claim 1.

In accordance with the inventive design, the adjusting accuracy attained on the panel-shaped solar module is largely unrelated to how the positioning force attained using a drive member is introduced into the rotary drive. The rotary drive for the individual solar module produces its accuracy itself to a certain extent. The rotatably-borne cam plate, in cooperation with a movable control member, achieves this. In accordance with the prescribed control contour, minor rotary movements of the cam plate up to a limiting angle cause nothing more than that the cam disk returns to a stable starting position. The control contour can also be designed such that given minor rotary movements below the limiting angle the control cam plate returns to a defined starting/center position. It is not until the limiting angle is exceeded that cam disk rotates further about one or a plurality of ratchet units.

Thus, in the case of the inventive rotary drive the issue is only that a sufficiently high rotary pulse reaches the cam plate from outside so that the latter continues rotating. Inaccuracies in a central drive, which are unavoidable in a group of solar modules, are compensated by this. It is enough that the rotary pulse introduced from outside is enough to advance even the “weakest” cam plate. Moreover, if more easily moved cam disks or even cam disks that have been positioned even further receive a rotary pulse that is too strong, this does no harm because due to the regularly ratcheted control contour the cam plate that has rotated too far returns to its stable starting/center position. Each cam plate stabilizes itself to a certain extent, so that it is even possible to speak of “mechanical digitization”. In this manner all solar modules in a group are positioned uniformly exactly together.

Claims 2 through 6 provide further embodiments of the rotary drive. The inventive rotary drive is described primarily in connection with the rotation of the panel-shaped solar module about the upright axis of rotation. However, it can basically also be used in the same manner for rotating horizontal axes.

In the course of one simplification of the rotary drives, however, in connection with the inventive rotary drive it is preferred that the solar modules can only rotate about an upright axis, while the inclined position of the solar modules relative to this axis is set to a value that is a usable temporal mean between the seasons. One embodiment suitable for this is described in the Applicant's German utility model with the number . . . (in house file K82417GM).

The invention also relates to a solar system for energy production that comprises a plurality of individual panel-shaped solar modules, of which each is controllably rotatable about an upright axis, whereby the drive occurs jointly or by group using mechanical transmission members by one or a plurality of central drive units and the rotary drives for the solar modules are embodied in accordance with claims 1 through 6.

Thus, in such a solar system, several or a plurality of solar modules could be actuated jointly by a central drive unit via the conventional mechanical drive members or coupling links such as chains, cables, or rods. The central drive unit can only provide the drive members or coupling links pulses of limited path lengths and must then be restored. The central drive unit acts only to introduce the energy for positioning the individual modules into the rotary drives. The positioning accuracy occurs in the rotary drives themselves.

The invention is explained in greater detail in the following using the drawings of exemplary embodiments. The following are depicted in the figures:

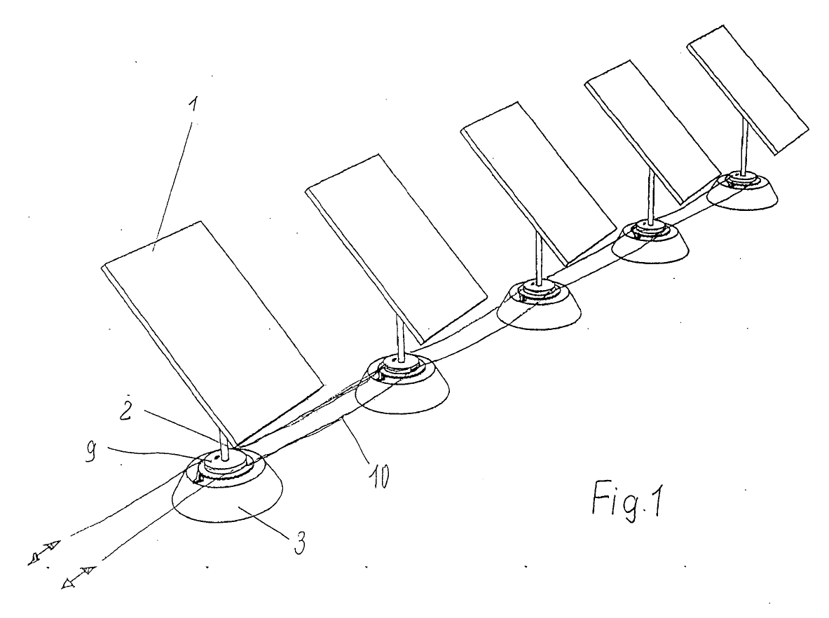

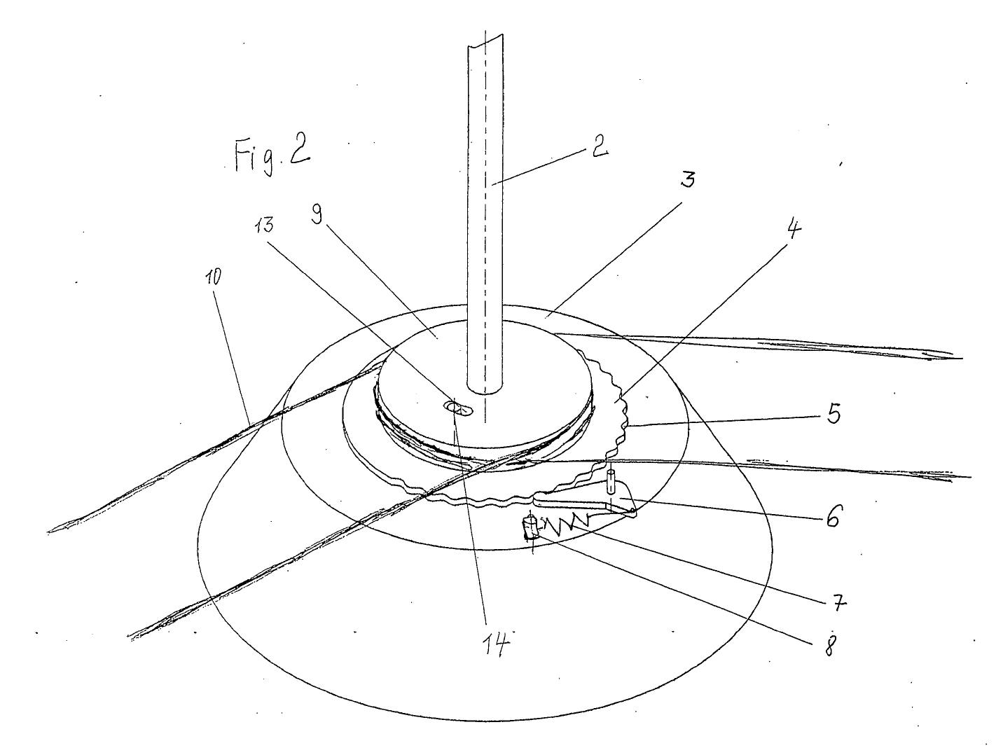

FIG. 1 illustrates a solar system with a plurality of rotatable panel-shaped solar modules.

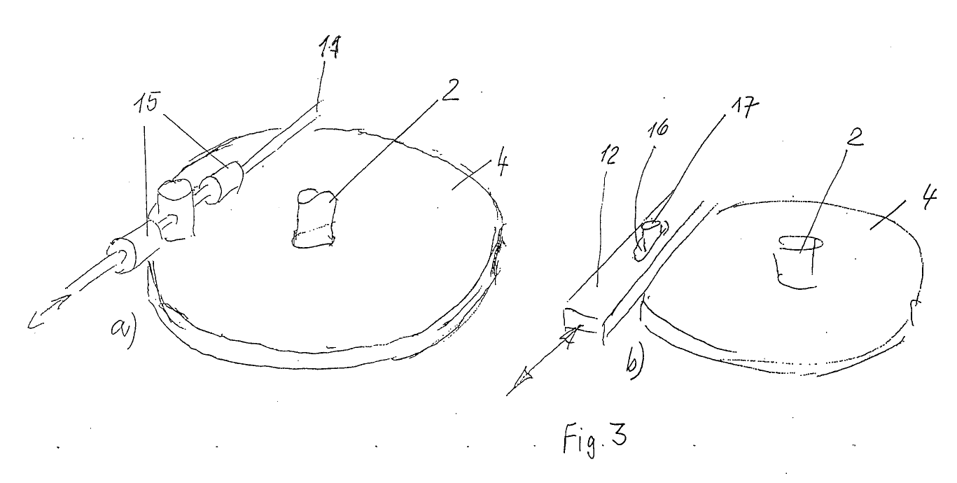

FIG. 2 depicts details of an inventive rotary drive.

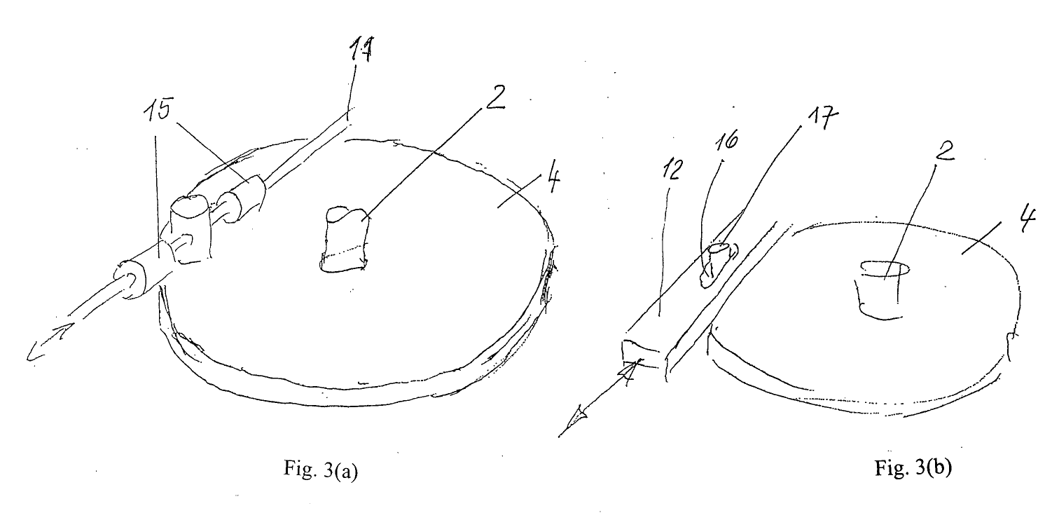

FIG. 3 provides two examples for directly introducing force into the cam plate 4 from linearly acting drive members.

FIG. 1 depicts how a plurality of rotatable solar modules are set up in a series. Each solar module is attached to a support axis 2 on its associated base 3. Drive members 9 for the base 3 are provided short, pulse-like rotary movements via transmission members 10, for which purpose the transmission members are moved back and forth. The joint drive unit for the transmission members is not shown, however. In accordance with the enlarged depiction in FIG. 2, the support axis is labeled 3, and the solar module 1 is arranged rotation-fast thereon and at an upward incline. The support axis 2 itself is joined rotation-fast to the cam plate 4, which is rotatably borne in the base 3, that is stationary. The cam plate 4 is the centerpiece of the entire drive. In the exemplary embodiment depicted, it is basically circular in shape. However, a control contour 5 is provided only on a 180-degree rotation path on the cam plate 4. The control contour 5 basically has the shape of wave-like teeth, the base of the gap between the teeth forming a stable starting/center position for the adjacent control member 6. The control member 6 is pivotably attached to the base 3 and is continuously drawn against the control contour 5 by means of a tension spring 7 that is attached to a pin 8.

The cam plate 4 and the control member 5 look like a ratchet wheel and pawl. In contrast thereto, however, the wave-like control contour 5 is embodied such that during minor rotational movements of the cam plate up to a certain limiting angle no advance occurs, but rather the gear disk returns to its stable starting/center position. It is not until the rotational movement exceeds a limiting angle that there is an advance by at least one ratchet unit in the control contour.

A drive member 9 rotates the control disk and here is also disk-shaped and rotatable on the support axis 2 and thus also relative to the control disk 4. A limited coupling movement between the drive member 9 and the cam plate 4 occurs using the curved oblong hole 13 in the drive member 9 and a pin 14 that is disposed on the cam plate 4. When the drive member 9 is rotated about a limiting angle that is large enough, via the pin 14 it carries the cam plate 4 so that the latter can be rotated further. The rotational movement is provided to the drive member 9 using a transmission member 10 that can only be moved back and forth in short segments. The oblong hole 13 permits the drive member 9 and the transmission member 10 to be rotated back and also compensates positioning differences in the group-wise arrangement of rotary drives.

FIG. 3 depicts other options for rotating the cam plate 4. In accordance with drawing a, a traction cable 11 acts as a drive member directly on the cam plate 4 via compensating springs 15.

In accordance with drawing b, a coupling rod 12 is provided, whereby the same described action occurs using the oblong hole 16 in the coupling rod 12 and the pin 17 on the cam plate 4.

1.-7. (canceled)

8. Apparatus comprising a panel-shaped solar module and a rotary drive for adjusting orientation of the solar module to a direction of solar radiation, wherein the rotary drive comprises
a rotatably supported cam plate non-rotatably connected to the solar module and acting as a ratchet wheel, the cam plate including a control contour comprising a plurality of uniformly spaced substantially identical teeth,
a control member acting as a pawl in cooperation with the teeth, and
a drive device for transmitting drive pulses through a path to the cam plate and wherein each drive pulse is for rotationally driving the cam plate by a step corresponding substantially to an angular distance from a space between an adjacent pair of said teeth to a next space between a next adjacent pair of said teeth, said path including a portion in which the drive device is disengaged from the cam plate.

9. Apparatus according to claim 8, further comprising an elongated upright support to which the solar module is attached, the support having a lengthwise axis substantially vertical to the ground when the apparatus is in use and the rotary drive being mounted for rotating the solar module about said axis.

10. Apparatus according to claim 8, wherein said cam plate is substantially in the shape of a circle or a sector of a circle of at least about 180° and the control contour comprises at least a portion of a periphery of the circle or sector of a circle.

11. Apparatus according to claim 8, wherein the drive device comprises a belt pulley or chain wheel provided with a curved oblong hole in which is received a pin which is fixed to the cam plate, said portion of said path comprising a path of movement of the pin in the hole.

12. Apparatus according to claim 8, wherein the drive device comprises a traction cable and compensating springs through which the traction cable is coupled to the cam plate.

13. Apparatus according to claim 8, wherein the drive device comprises a rigid elongated member provided with an oblong hole in which is received a pin which is fixed to the cam plate, said portion of said path comprising a path of movement of the pin in the hole.

14. An array of solar modules comprising a plurality of apparatuses according to claim 9 and mechanical transmission devices interconnecting the respective rotary drives for driving the plurality of apparatuses through a common source of motive power.
